(19) United States
(12) Patent Application Publication
(10) Pub. No.: US 2004/0076881 A1
(43) Pub. Date: Apr. 22, 2004

(54) Method of making a battery

(76) Inventors: William L. Bowden, Nashua, NH (US); Paul A. Christian, Norton, MA (US); Richard E. Durkot, East Walpole, MA (US); Rimma A. Sirotina, Ashland, MA (US)

Correspondence Address: FISH & RICHARDSON P.C., 1425 K STREET, N.W., 11TH FLOOR, WASHINGTON, DC, 20005-3500, US

(21) Appl. No.: 10/271,979

(22) Filed: Oct. 17, 2002

(51) Int. Cl. H01M 10/04

(52) U.S. Cl. 429/223; 429/206; 429/164

(57) ABSTRACT

A method of making a battery includes selecting selecting a sample of nickel oxyhydroxide, incorporating the sample of nickel oxyhydroxide into a battery, and determining the voltage peak capacity of the battery.

### TECHNICAL FIELD

This invention relates to methods of constructing and evaluating an alkaline battery.

### BACKGROUND

Batteries, such as alkaline batteries, are commonly used as energy sources. Generally, alkaline batteries have a cathode, an anode, a separator and an alkaline electrolyte solution. The cathode can include a cathode material (e.g., manganese dioxide or nickel oxyhydroxide), carbon particles that enhance the conductivity of the cathode, and a binder. The anode can be formed of a gel including zinc particles. The separator is disposed between the cathode and the anode. The alkaline electrolyte solution, which is dispersed throughout the battery, can be an aqueous hydroxide solution such as potassium hydroxide.

Some devices, such as digital cameras and cellular telephones, can demand high power from batteries. In such applications, it is desirable for the batteries, e.g., primary alkaline batteries, to have good performance and long lifetimes at high current discharge.

### SUMMARY

The invention relates to a method of selecting nickel oxyhydroxide for alkaline batteries. The method includes using stepped potential electrochemical spectroscopy (“SPECS”) to select the nickel oxyhydroxide. The SPECS results yield a voltage peak capacity or a maximum power divided by power peak width at half height that can be used to select a nickel oxyhydroxide suitable for use as a cathode material in a battery.

In one aspect, a method of making a battery includes selecting a sample of an active cathode material, incorporating the sample of the active cathode material into a battery, and determining the voltage peak capacity of the battery. The active cathode material can be nickel oxyhydroxide.

In another aspect, a method of making a battery includes identifying a sample of nickel oxyhydroxide having a peak capacity of least about 0.065 Ampere-hours/0.005 Volts in a AA cell, a maximum power divided by power peak width at half height of at least about 0.90 Watts/Volt in a AA cell, or a maximum power divided by power peak width at half height of at least about 0.55 Watts/Volt in a 635 cell, incorporating the sample of nickel oxyhydroxide into a cathode, and incorporating the cathode into a battery.

In another aspect, an alkaline battery includes a cathode including a nickel oxyhydroxide, an anode, a separator between the anode and the cathode, and an alkaline electrolyte contacting the anode and the cathode. The nickel oxyhydroxide has a peak capacity of least about 0.065 Ampere-hours/0.005 Volts in a AA cell, a maximum power divided by power peak width at half height of at least about 0.90 Watts/Volt in a AA cell, or a maximum power divided by power peak width at half height of at least about 0.55 Watts/Volt in a 635 cell. The anode can include zinc. The battery can be a AA, AAA, AAAA, C, or D battery.

The sample can be selected by determining the peak capacity or maximum power divided by power peak width at half height. The peak capacity of the battery can be at least about 0.065, at least about 0.070, or at least about 0.075 Ampere-hours/0.005 Volts in a AA cell. The maximum power divided by power peak width at half height can be at least about 0.90 or at least about 0.95 Watts/Volt in a AA cell, or the maximum power divided by power peak width at half height of at least about 0.55 Watts/Volt in a 635 cell.

An alkaline Zn/NiOOH cell especially suitable for discharge under high drain conditions can have a cathode including NiOOH with a high peak voltage and narrow peak width as characterized by discharge using the Stepped Potential Electrochemical Spectroscopy (SPECS) technique. The nickel oxyhydroxide material can be selected by the SPECS technique to be well suited to discharge at high current. In other words, SPECS can be used to identify suitable NiOOH materials for use in high drain batteries. This can allow rapid identification of high power capable materials in an economical manner.

Other features and advantages of the invention will be apparent from the description and drawings, and from the claims.

### DESCRIPTION OF DRAWINGS

FIG. 1 is a cross-section view of a battery.

FIG. 2 is a qualitative plot of voltage vs. time as can be used in stepped potential electrochemical spectroscopy (“SPECS”).

FIG. 3 is a qualitative plot of current vs. time as can be obtained from SPECS.

FIG. 4 is a qualitative plot of maximum and minimum power vs. voltage as can be obtained from SPECS.

FIG. 5 is a plot of power vs. voltage for a nickel oxyhydroxide containing cell.

FIGS. 6A and 6B are plots of capacity vs. voltage and power vs. voltage, respectively, for a nickel oxyhydroxide containing cell.

### DETAILED DESCRIPTION

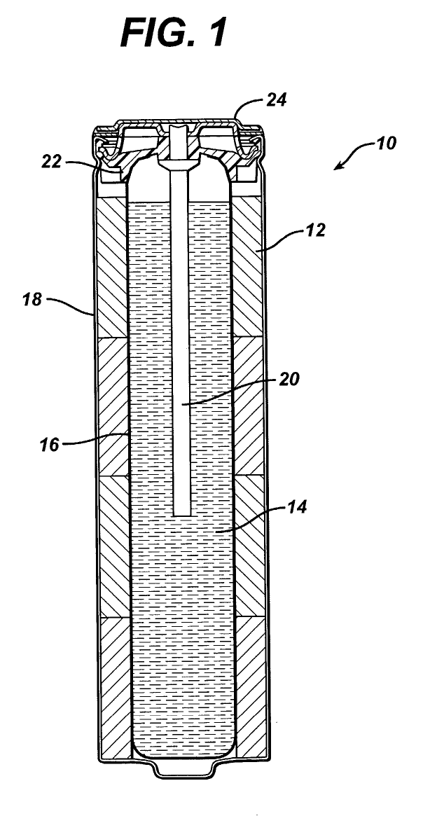

Referring to FIG. 1, battery 10 includes a cathode 12, an anode 14, a separator 16, and a cylindrical housing 18. Battery 10 also includes a current collector 20, a seal 22, and a negative metal top cap 24, which serves as the negative terminal for the battery. Cathode 12 is in contact with housing 18, and the positive terminal of battery 10 is at the opposite end of battery 10 from the negative terminal. An electrolytic solution is dispersed throughout battery 10. Battery 10 can be, for example, a AA, AAA, AAAA, C, or D battery.

Cathode 12 includes a nickel oxyhydroxide. Cathode 12 can also include carbon particles and a binder. The nickel oxyhydroxide can be commercially available, for example, from H. C. Starck GmbH & Co. (Goslar, Germany), Tanaka Chemical or Kansai Catalyst Company. Alternatively, the nickel oxyhydroxide can be prepared, for example, by the methods described in U.S. Ser. No. 09/633,067, filed Aug. 4, 2000, and U.S. Ser. No. 10/086,807, filed Mar. 4, 2002, each of which is incorporated by reference in its entirety. The nickel oxyhydroxide can include a beta-nickel oxyhydroxide, a cobalt oxyhydroxide-coated beta-nickel oxyhydroxide, a gamma-nickel oxyhydroxide, or a cobalt oxyhydroxide-coated gamma-nickel oxyhydroxide. Optionally, cathode 12 can also include an oxidative additive, or a binder, or both. Generally, the cathode can include, for example, between 60% by weight and 97% by weight, between 80% by weight and 95% by weight, or between 85% by weight and 90% by weight of cathode material.

The nickel oxyhydroxide suitable for use in a battery is selected by screening the material in a battery using SPECS. SPECS has been described in, for example, A. H. Thompson, Electrochemical Potential Spectroscopy: A New Electrochemical Measurement, J. Electrochemical Society 126(4), 608-616 (1979); Y. Chabre and J. Pannetier, Structural and Electrochemical Properties of the Proton/γ-MnO₂ System, Prog. Solid St. Chem. 23, 1-130 (1995); and references therein, each of which is hereby incorporated by reference in its entirety.

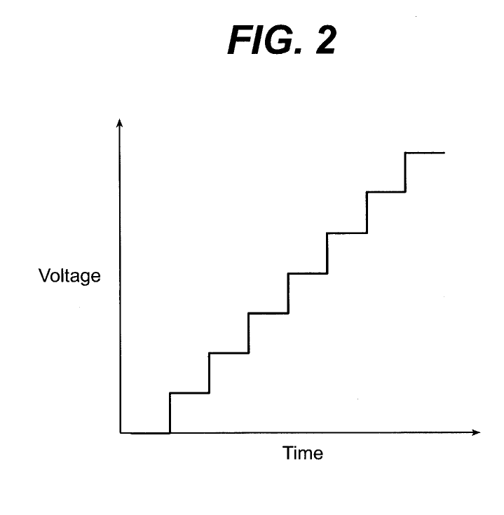

Generally, SPECS involves applying a series of increasing or decreasing potential steps to a cell containing a test material. Each potential step can be applied for a predetermined dwell time. As shown in FIG. 2, this produces a “voltage staircase” profile of the applied voltage as a function of time.

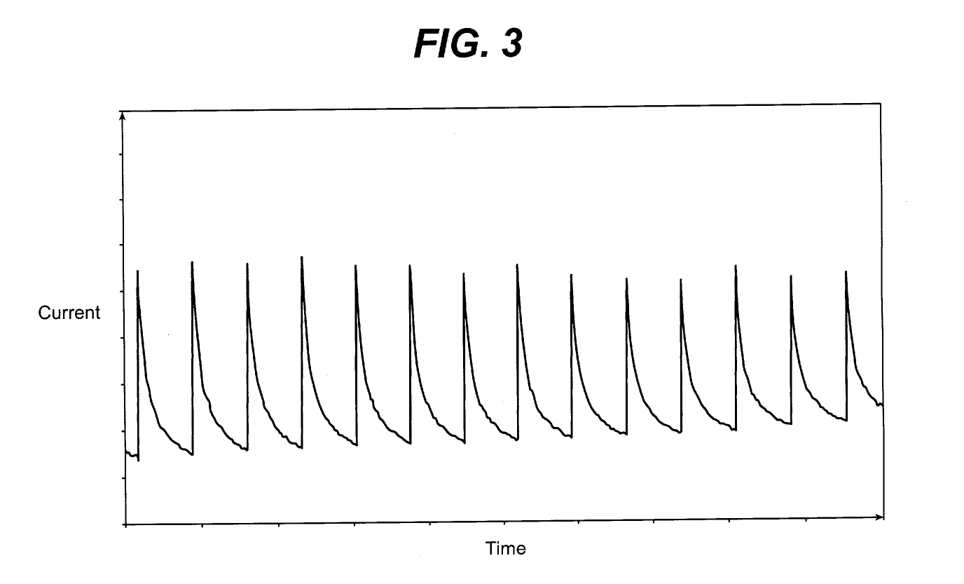

The current can also be measured as a function of time for each voltage step, e.g., the current can be continuously measured or measured at some predetermined interval. For example, FIG. 3 depicts the current-time plot for a sample of MnO₂. The general features of the graph are not particularly different when the material is a nickel oxyhydroxide. As shown in FIG. 3, for each voltage step the cell generally discharges a maximum current, Iₘₐₓ, and then decays to a minimum current, Iₘᵢₙ.

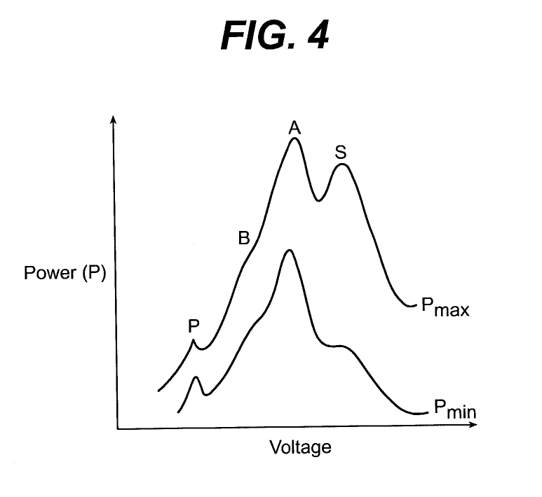

Using the standard relationship that power is equal to current multiplied by voltage, a plot of the current as a function of time can be converted to a plot of power as a function of time. Moreover, by using the relationship between voltage and time depicted in FIG. 3, a plot of power as a function of time can be converted to a plot of power as a function of voltage. For example, a plot of the maximum current as a function of time (FIG. 3) and the minimum current as a function of time (FIG. 3) can be converted to a plot of maximum power as a function of voltage (FIG. 4) and a plot of the minimum power as a function of voltage (FIG. 4), respectively.

As shown in FIG. 4, the power-voltage plot of a sample of MnO₂ can exhibit four features or peaks, commonly labeled P, B, A, and S. Without wishing to be bound by theory, feature P, generally at about 1.1 V, is believed to correspond to the reduction of Mn⁴⁺ located in the pyrolusite (rutile) phase of gamma-MnO₂. Features B and A, generally at about 1.2-1.3 V and at about 1.3 V, respectively, are believed to correspond to the reduction of the ramsdellite phase of gamma-MnO₂. Feature S, generally at about 1.45 V, is believed to correspond to the reduction of surface states located at microtwinning defects. Different samples of manganese dioxide can have different absolute and/or relative intensities for the P, B, A, and/or S peaks in their respective power-voltage plots. For example, a sample of MnO₂ can have a relatively high S peak and a relatively high P peak, or a relatively low S peak and a relatively high P peak, or various other combinations. The important features of a SPECS plot for nickel oxyhydroxide are the voltage peak capacity and the maximum power divided by power peak width at half height.

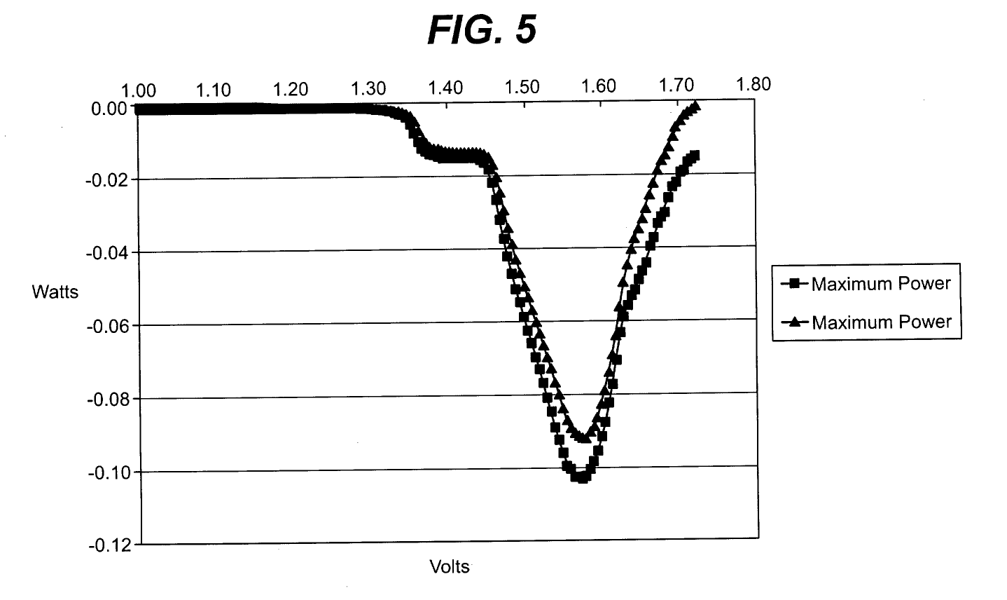

A plot of maximum and minimum power for a typical nickel oxyhydroxide sample is shown in FIG. 5. While the maximum and minimum power are easily discerned, it is clear that a single discharge process dominates the SPECS plot. For nickel oxyhydroxide samples, the method described in U. S. Pat. No. 6,440,181 can generate less useful information than the method described herein. The cell tested in FIG. 5 had a maximum power of 0.103 Watts at 1.572 volts and minimum power of 0.918 watts at 1.572 Volts.

In general, the SPECS data, e.g., current, power and/or capacity, for a given type of nickel oxyhydroxide increases as the weight a sample of the nickel oxyhydroxide increases. Therefore, to compare the SPECS data for samples of nickel oxyhydroxide having different weights, the SPECS data should be normalized to the weight of each sample. For example, to compare the P peaks in the maximum power-voltage plots of two samples of nickel oxyhydroxides having different weights, the maximum power peak for the first sample should be divided by the weight the first sample, and the maximum power peak for the second sample should be divided by the weight of the second sample.

Numerous experimental conditions for SPECS can also be used to obtain the plots discussed herein. Generally, the experimental conditions to be selected include the voltage step, typically 0.005 V and a limiting condition, which can include dwell time and/or a limiting current, e.g., Iₘᵢₙ. Typically, dwell time is selected as the limiting condition because data manipulation can be convenient. The conditions are preferably selected so that the resulting plots, e.g., power vs. voltage and capacity vs. voltage, have well-resolved P, B, A, and S peaks. The rate of current discharge should generally allow observation of the sharp P feature. Also, because the B peak can affect the magnitude of the P peak, which is used to calculate the power coefficient, the rate of discharge should also generally be fast enough to show the presence of the kinetically hindered B peak (the shoulder near 1.2 V) and detailed enough with regard to voltage step to reveal the shoulder. Generally, voltage steps of greater than about 20 mV/hr can cause shifts in peak voltages that can complicate data interpretation. Voltage steps greater than about 10 mV may results in plots having an unresolved B shoulder, whereas small voltage steps and short sample intervals can provide good resolution, at some cost to absolute accuracy. Accordingly, preferred experimental conditions can include voltage steps of about 2.5 mV to about 10 mV, e.g., about 5 mV. Dwell times that are too short, e.g., about 15 minutes, provide inadequate resolution, but dwell times that are too long, e.g., greater than about 6 hours, require an undue length of time for measurements. Therefore, preferred dwell times are typically from about 30 minutes to about 2 hours.

The carbon particles in cathode 12 can be, for example, non-expanded graphite particles, expanded graphite particles, or a blend of non-expanded graphite particles and expanded graphite particles. The graphite can be synthetic or non-synthetic, or a blend of synthetic and non-synthetic.

The carbon particles can include graphite particles. The graphite particles can be synthetic graphite particles, including expanded graphite, non-synthetic, or natural graphite, or a blend thereof. Suitable graphite particles can be obtained from, for example, Brazilian Nacional de Grafite of Itapecerica, MG Brazil (e.g., NdG grade MP-0702X) Chuetsu Graphite Works, Ltd. (e.g., Chuetsu grades WH-20A and WH-20AF) of Japan or Timcal America of Westlake, Ohio (e.g., Timcal grade EBNB-90). The cathode can include, for example, between 1 wt % and 40 wt %, between 2 wt % and 10 wt %, or between 3 wt % and 8 wt % of carbon particles or blend of carbon particles. For lower graphite containing cathodes (e.g., <10 wt % ), a portion of the natural graphite ranging from 10 to 90%, from 25 to 75%, or from 40 to 60% by weight can be substituted by an expanded graphite.

The expanded graphite particles preferably have an average particle size of less than 40 microns, more preferably between 18 microns and 30 microns, and most preferably between 24 microns and 28 microns. Expanded graphite particles may be purchased, for example, from Chuetsu Graphite Works, Ltd. (Chuetsu grades WH-20A and WH-20AF) of Japan.

Examples of binders can include a polymer such as polyethylene, polyacrylamide, or a fluorocarbon resin, such as PVDF or PTFE. An example of a polyethylene binder is sold under the trade name COATHYLENE HA-1681 (available from Hoechst). The cathode can include, for example, between 0.05 wt % and 5 wt %, or between 0.1 wt % and 2 wt % binder.

A portion of the electrolyte solution can be dispersed through cathode 12, and the weight percentages provided above and below are determined after the electrolyte solution has been dispersed.

Anode 14 can be formed of any of the standard zinc materials used in battery anodes. For example, anode 14 can be a zinc gel that includes zinc metal particles, a gelling agent, and minor amounts of additives, such as gassing inhibitor. In addition, a portion of the electrolyte solution is dispersed throughout the anode.

The zinc particles can be any of the zinc particles conventionally used in gel anodes. Examples of zinc particles include those described in U.S. Ser. No 08/905,254, U.S. Ser. No. 09/115,867, and U.S. Ser. No. 09/156,915, which are assigned to the assignee in the present application and each of which is incorporated by reference in its entirety. The anode may include, for example, between 67% and 71% of zinc particles by weight.

Examples of gelling agents include polyacrylic acids, grafted starch materials, salts of polyacrylic acids, polyacrylates, carboxymethylcellulose or combinations thereof. Examples of such polyacrylic acids are Carbopol 940 and 934 (available from B.F. Goodrich) and Polygel 4P (available from 3V), and an example of a grafted starch material is Waterlock A221 (available from Grain Processing Corporation, Muscatine, Iowa ). An example of a salt of a polyacrylic acid is Alcosorb G1 (available from Ciba Specialties). The anode may include, for example, from 0.1 percent to about 1 percent gelling agent by weight.

Gassing inhibitors can be inorganic materials, such as bismuth, tin, lead and indium. Alternatively, gassing inhibitors can be organic compounds, such as phosphate esters, ionic surfactants or nonionic surfactants. Examples of ionic surfactants are disclosed in, for example, U.S. Pat. No. 4,777,100, which is hereby incorporated by reference in its entirety.

Separator 16 can have any of the conventional designs for battery separators. In some embodiments, separator 16 can be formed of two layers of non-woven, non-membrane material with one layer being disposed along a surface of the other. To minimize the volume of separator 16 while providing an efficient battery, each layer of non-woven, non-membrane material an have a basic weight of about 54 grams per square meter, a thickness of about 5.4 mils when dry and a thickness of about 10 mils when wet. In these embodiments, the separator preferably does not include a layer of membrane material or a layer of adhesive between the non-woven, non-membrane layers. Generally, the layers can be substantially devoid of fillers, such as inorganic particles.

In other embodiments, separator 16 includes an outer layer of cellophane with a layer of non-woven material. The separator also includes an additional layer of non-woven material. The cellophane layer can be adjacent cathode 12 or the anode. Preferably, the non-woven material contains from about 78 weight percent to about 82 weight percent PVA and from about 18 weight percent to about 22 weight percent rayon with a trace of surfactant. Such non-woven materials are available from PDM under the tradename PA25.

The electrolytic solution dispersed throughout battery 10 can be any of the conventional electrolytic solutions used in batteries. Typically, the electrolytic solution is an aqueous hydroxide solution. Such aqueous hydroxide solutions include potassium hydroxide solutions including, for example, between 33 and 38 by weight percent potassium hydroxide, and sodium hydroxide solutions. The electrolyte can also include about 2 by weight percent zinc oxide.

Housing 18 can be any conventional housing commonly used in primary alkaline batteries. The housing typically includes an inner metal wall and an outer electrically non-conductive material such as heat shrinkable plastic. Optionally, a layer of conductive material can be disposed between the inner wall and the cathode 12. This layer may be disposed along the inner surface of wall, along the circumference of cathode 12 or both. This conductive layer can be formed, for example, of a carbonaceous material. Such materials include LB1000 (Timcal), Eccocoat 257 (W.R. Grace & Co.), Electrodag 109 (Acheson Colloids Co.), Electrodag 112 (Acheson) and EB0005 (Acheson). Methods of applying the conductive layer are disclosed in, for example, Canadian Pat. No. 1,263,697, which is hereby incorporated by reference in its entirety.

Current collector 20 is made from a suitable metal, such as brass. Seal 22 can be made, for example, of nylon.

The following examples are for illustrative purposes only and are not intended as limiting.

### Examples

Cells were prepared as AA cells (Example 1) or 635 button cells (Examples 2, 3, 4 and 5). In Example 1, cobalt coated nickel oxyhydroxide from Kansai was used. In comparative Example 1, nickel oxyhydroxide from Tanaka was used. In comparative Example 2, nickel oxyhydroxide from H. C. Starck and oxidized by ozone as described in U.S. Ser. No. 10/0868,807 was used. In comparative Example 3, nickel oxyhydroxide from H. C. Starck was used. The three samples labeled Example 1, Example 1A and Example 1B were made with multiple permutations of anode fines, % solids and involved both C and Au plated cans showing the robustness of the technique. Example 1 had no fines zinc in the anode and 64 wt % zinc in the anode while Examples 1A and 1B had 64 wt % zinc in the anode of which 50% was fine zinc.

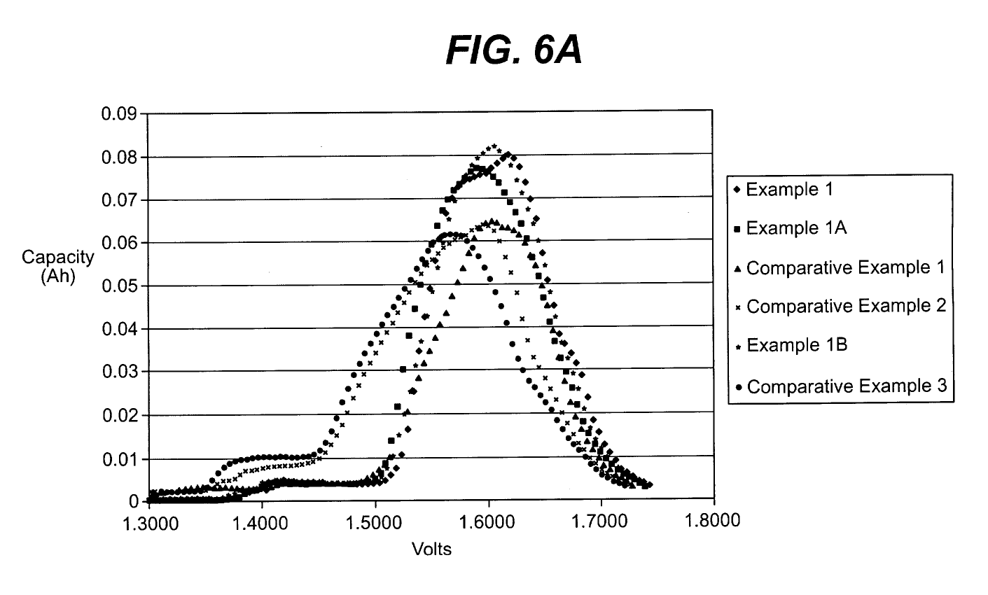

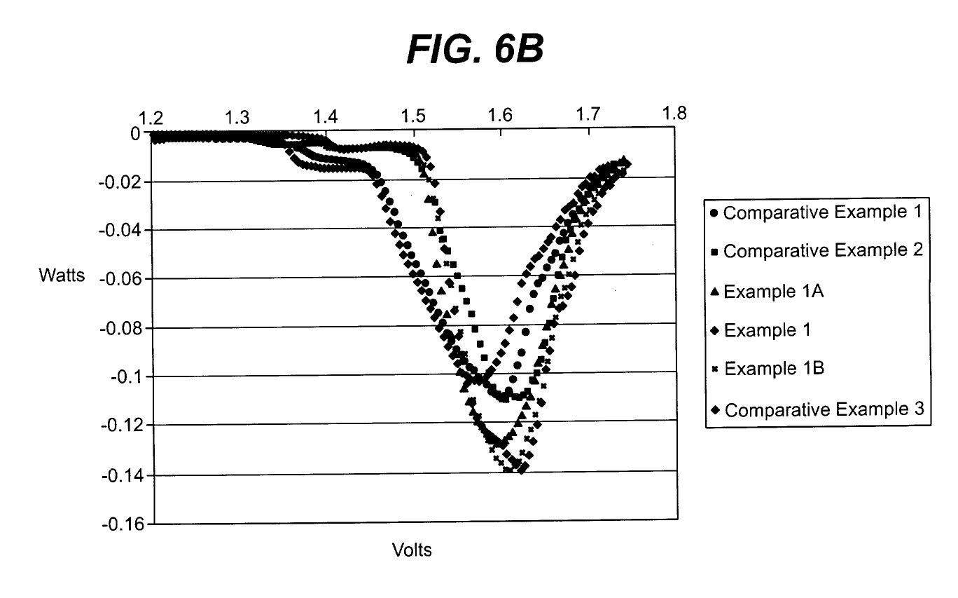

Each cell was tabbed and discharged using a potentiostat (Arbin multistation) according to the “voltage staircase” function. All electrochemical testing was done on an Arbin multichannel potentiostat using a voltage staircase regime of 5 millivolt steps each hour. The dwell time was 1 hr. Data points were collected approximately every two minutes. Exemplary plots of capacity vs. voltage is shown in FIG. 6A, and maximum power vs. voltage are shown in FIG. 6B. The low current SPECS of the NiOOH cells appear to mimic that of alkaline manganese AA cells in that it shows major differences due to the NiOOH source. SPECS test results for the NiOOH cells for Example 1, Comparative Example 2, and Comparative Example 1 are shown in FIGS. 6A and 6B.

As shown in FIG. 6A, the Example 1 and comparative Example 2 had a higher voltage for peak capacity than either comparative Example 1 or comparative Example 3. In addition, Example 1 had a narrower discharge peak suggesting a higher power capability. Comparison of power capability shown below demonstrates that under the SPECS test with the caveats outlined above, the material used in Example 1 had about 40% greater peak power than the material used in comparative Example 3. The performance of the cells can be improved by including gold coatings on the cans or including additional graphite in the cells.

Table 1 includes data that compare high rate power of the Example and Comparative Example materials with the peak width at half height (PWHH), peak voltage for the NiOOH materials.

TABLE 1

| | Peak | Peak | | | | |
|---|---|---|---|---|---|---|
| | Voltage | Power | | Peak Power/ | Load V | 1 W to |
| Example | (V) | (W) | PWHH | PWHH | (AA) | 1.1 V |
| EX 1 | 1.6194 | 0.0140 | 0.130 | 1.076 | 1.32 | 1.35 |
| EX 1A | 1.6013 | 0.014 | 0.128 | 1.094 | 1.35 | 1.29 |
| EX. 1B | 1.5902 | 0.129 | 0.130 | 0.992 | 1.19 | 1.39 |
| Comp | 1.6037 | 0.111 | 0.125 | 0.888 | 0.996 | 0.91 |
| Ex. 1 | | | | | | |
| Comp | 1.5959 | 0.109 | 0.161 | 0.677 | 0.84 | 1.04 |
| Ex 2 | | | | | | |
| Comp | 1.5722 | 0.103 | 0.165 | 0.624 | 1.09 | 1.22 |
| Ex 3 | | | | | | |

As shown in Table 1, a peak power divided by peak width at half height of over 0.9 corresponds to good service on 1 W testing and good load voltage in a 6 A 0.1 second test, which assesses the power capability of the cell. The 6A 0.1 second test involves applying the stated load for 0.1 seconds and recording the cell voltage at the end of the 0.1 second pulse.

Using the SPECS test vehicle for the 635 size cell, the peak half width was small as shown by this figure with four samples of different NiOOH materials (Examples 2, 3, 4, 5). The results are summarized in Table 2. The four samples were selected to have different levels of cobalt content either on the surface or in the bulk of the materials. Example 1 had no cobalt, Example 2 has 4% Co as a surface coating, Example 3 had 1% Co as a bulk dopant, and Example 4 had both 4% surface Co and 1% bulk Co.

TABLE 2

| | Peak | | Peak width at | |
|---|---|---|---|---|
| | Voltage | Peak Power | half height | Peak Power/ |
| Example | (V) | (W) | (PWHH) | PWHH |
| Ex. 2 | 1.6799 | 0.0381 | 0.0573 | 0.6649 |
| Ex. 3 | 1.6808 | 0.0361 | 0.0567 | 0.6367 |
| Ex. 4 | 1.6658 | 0.0364 | 0.063 | 0.5778 |
| Ex. 5 | 1.6676 | 0.0352 | 0.062 | 0.5677 |
| Comp. Ex. 4 | 1.6642 | 0.0278 | 0.080 | 0.3475 |
| Comp. Ex. 5 | 1.6548 | 0.0250 | 0.070 | 0.3571 |
| Comp. Ex. 6 | 1.6451 | 0.0262 | 0.075 | 0.3493 |

Data relating to capacity differences in the SPECS experiment can also be used to characterize the materials, as shown in Table 3.

TABLE 3

| | | | Peak width at | Peak |
|---|---|---|---|---|
| | Peak Voltage | | half height | Capacity/ |
| Example | (V) | Peak Capacity | (PWHH) | PWHH |
| EX 1 | 1.6062 | 0.0818 | 0.1165 | 0.7024 |
| EX 1A | 1.6191 | 0.0800 | 0.1196 | 0.6689 |
| EX 1B | 1.5902 | 0.0768 | 0.1298 | 0.5917 |
| Comp. Ex. 1 | 1.6037 | 0.0646 | 0.1197 | 0.5397 |
| Comp Ex. 2 | 1.6011 | 0.0634 | 0.145 | 0.436 |
| Comp Ex. 3 | 1.5722 | 0.0614 | 0.1402 | 0.4379 |

Other embodiments are within the claims.

What is claimed is:

1. A method of making a battery comprising:
selecting a sample of nickel oxyhydroxide;
incorporating the sample of nickel oxyhydroxide into a battery; and
determining the peak capacity of the battery.

2. The method of claim 1, wherein the peak capacity of the battery is at least about 0.065 Ampere-hours/0.005 Volts in a AA cell.

3. The method of claim 1, wherein the peak capacity of the battery is at least about 0.070 Ampere-hours/0.005 Volts in a AA cell.

4. The method of claim 1, wherein the peak capacity of the battery is at least about 0.075 Ampere-hours/0.005 Volts in a AA cell.

5. The method of claim 1, wherein the maximum power divided by power peak width at half height is at least about 0.90 Watts/Volt in a AA cell.

6. The method of claim 1, wherein the maximum power divided by power peak width at half height is at least about 0.95 Watts/Volt in a AA cell.

7. A method of making a battery, the method comprising:
identifying a sample of nickel oxyhydroxide having a peak capacity of least about 0.065 Ampere-hours/0.005 Volts in a AA cell, a maximum power divided by power peak width at half height of at least about 0.90 Watts/Volt in a AA cell, or a maximum power divided by power peak width at half height of at least about 0.55 Watts/Volt in a 635 cell;
incorporating the sample of nickel oxyhydroxide into a cathode; and
incorporating the cathode into a battery.

8. The method of claim 7, wherein the peak capacity is at least about 0.070 Ampere-hours/0.005 Volts in a AA cell.

9. The method of claim 7, wherein the peak capacity is at least about 0.075 Ampere-hours/0.005 Volts in a AA cell.

10. The method of claim 7, wherein the maximum power divided by power peak width at half height is at least about 0.90 Watts/Volt in a AA cell.

11. An alkaline battery comprising:
a cathode comprising a nickel oxyhydroxide, the nickel oxyhydroxide having a peak capacity of least about 0.065 Ampere-hours/0.005 Volts in a AA cell, a maximum power divided by power peak width at half height of at least about 0.90 Watts/Volt in a AA cell, or a maximum power divided by power peak width at half height of at least about 0.55 Watts/Volt in a 635 cell;
an anode;
a separator between the anode and the cathode; and
an alkaline electrolyte contacting the anode and the cathode.

12. The battery of claim 11, wherein the peak capacity is at least about 0.070 Ampere-hours/0.005 Volts in a AA cell.

13. The battery of claim 11, wherein the peak capacity is at least about 0.075 Ampere-hours/0.005 Volts in a AA cell.

14. The battery of claim 11, wherein the voltage peak capacity is at least about 0.075 Ampere-hours/0.005 Volts in a AA cell.

15. The battery of claim 11, wherein the maximum power divided by power peak width at half height is at least about 0.90 Watts/Volt in a AA cell.

16. The battery of claim 1, wherein the anode includes zinc.

17. The battery of claim 11, wherein the battery is a AA, AAA, AAAA, C, or D battery.

18. The battery of claim 16, wherein the battery is a AA, AAA, AAAA, C, or D battery.
